(19) United States
(12) Patent Application Publication
(10) Pub. No.: US 2016/0137550 A1
(43) Pub. Date: May 19, 2016

(54) TEMPERED GLASS AND GLASS FOR TEMPERING

(71) Applicant: NIPPON ELECTRIC GLASS CO., LTD., Shiga (JP)

(72) Inventors: Takashi MURATA, Shiga (JP); Takako TOJYO, Shiga (JP)

(73) Assignee: Nippon Electric Glass Co., Ltd., Shiga (JP)

(21) Appl. No.: 14/898,823

(22) PCT Filed: Jul. 3, 2014
(86) PCT No.: PCT/JP2014/067783

§ 371 Date: Dec. 16, 2015

(30) Foreign Application Priority Data
Jul. 8, 2013 (JP) 2013-142258

(51) Int. Cl. C03C 21/00; C03C 3/083; C03C 3/091; C03B 23/03; C03C 19/00

(52) U.S. Cl. CPC C03C 21/002; C03B 23/03; C03C 19/00; C03C 3/091; C03C 3/083

(57) ABSTRACT

A tempered glass having a compressive stress layer in a surface thereof, in which the tempered glass includes as a glass composition, in terms of mass o, 45% to 75% of SiO₂, 10% to 30% of Al₂O₃, 0% to 20% of B₂O₃, and 10% to 25% of Na₂O.

### TECHNICAL FIELD

The present invention relates to a tempered glass and a glass to be tempered, and more particularly, to a tempered glass and a glass to be tempered which are suitable for exterior parts for a mobile PC and the like.

### BACKGROUND ART

Mobile phones having touch panels mounted thereon have been widespread. A glass subjected to tempering treatment, such as ion exchange treatment (so-called tempered glass), is used for cover glasses for such mobile phones. The tempered glass is high in mechanical strength as compared to an untempered glass, and hence is suitable for this application (see Patent Literature 1 and Non Patent Literature 1).

In recent years, touch panels are being mounted for applications other than mobile phones as well, and hence, exterior parts each having a specific shape, such as a bent portion and/or a curved portion, are necessary in some of the applications. A tempered glass having such specific shape may be produced by, for example, forming molten glass into a flat sheet shape to obtain a glass substrate to be tempered, and then subjecting the glass substrate to be tempered to thermal processing to modify the shape of the glass substrate to the specific shape, followed by tempering treatment (see Patent Literatures 2 and 3).

Therefore, excellent thermal processability is required for obtaining the tempered glass having a specific shape.

### CITATION LIST

Patent Literature 1: JP 2006-83045 A

Patent Literature 2: US 7168047 B2

Patent Literature 3: JP 2001-247342 A

Non Patent Literature 1: Tetsuro Izumitani et al., “New glass and physical properties thereof,” First edition, Management System Laboratory. Co., Ltd., Aug. 20, 1984, p. 451-498

### SUMMARY OF INVENTION

### Technical Problem

Incidentally, a compressive stress layer is formed in the surface of the tempered glass. In general, the mechanical strength of the tempered glass can be increased by increasing the compressive stress value CS and/or depth of layer DOL of the compressive stress layer.

When the content of Al₂O₃ is increased in a glass composition, ion exchange performance is improved, and the compressive stress value CS and/or depth of layer DOL of the compressive stress layer can be increased. However, an increase in the content of Al₂O₃ in the glass composition causes an increase in softening point, and hence the thermal processability is liable to lower. Therefore, it is difficult to achieve both the ion exchange performance and the thermal processability.

Thus, the present invention has been made in view of such circumstances, and a technical object of the present invention is to devise a tempered glass and a glass to be tempered which can achieve both ion exchange performance and thermal processability.

### Solution to Problem

The inventors of the present invention have made extensive investigations. As a result, the inventors have found that both the ion exchange performance and the thermal processability can be achieved by restricting the glass composition within a predetermined range. Thus, the inventors propose the finding as the present invention. That is, a tempered glass according to one embodiment of the present invention is a tempered glass having a compressive stress layer in a surface thereof, wherein the tempered glass comprises as a glass composition, in terms of mass %, 45% to 75% of SiO₂, 10% to 30% of Al₂O₃, 0% to 20% of B₂O₃, and 10% to 25% of Na₂O.

In the tempered glass according to the embodiment of the present invention, it is preferred that the tempered glass have a bent portion and/or a curved portion.

In the tempered glass according to the embodiment of the present invention, it is preferred that the bent portion and/or the curved portion be formed through thermal processing. Herein, the “thermal processing” includes not only applying heat to a glass to modify the shape of the glass to a predetermined shape, but also pouring molten glass into a forming mold and pressing the glass as required to form the glass into a predetermined shape, and in addition, subjecting the molten glass to roll forming with a roller having a specific shape to form the glass into a predetermined shape.

In the tempered glass according to the embodiment of the present invention, it is preferred that the tempered glass be obtained through tempering treatment after the thermal processing.

In the tempered glass according to the embodiment of the present invention, it is preferred that an end surface of the tempered glass be subjected to grinding treatment and/or polishing treatment after the thermal processing and before tempering treatment.

In the tempered glass according to the embodiment of the present invention, it is preferred that the compressive stress layer have a compressive stress value CS of 500 MPa or more and a depth of layer DOL of 20 μm or more. Herein, the “compressive stress value CS of a compressive stress layer” and “depth of layer DOL” refer to values calculated by observing the number of interference fringes and the intervals between the fringes by using a surface stress meter (for example, FSM-6000 manufactured by Toshiba Corporation).

In the tempered glass according to the embodiment of the present invention, it is preferred that the tempered glass have a softening point of 800° C. or less. Herein, the “softening point” refers to a value measured based on a method of ASTM C338.

In the tempered glass according to the embodiment of the present invention, it is preferred that the tempered glass have an annealing point of 600° C. or less. Herein, the “annealing point” refers to a value measured based on a method of ASTM C336.

In the tempered glass according to the embodiment of the present invention, it is preferred that the tempered glass have a strain point of 400° C. or more. Herein, the “strain point” refers to a value measured based on a method according to ASTM C336.

In the tempered glass according to the embodiment of the present invention, it is preferred that the tempered glass have a liquidus temperature of 1,200° C. or less. Herein, the “liquidus temperature” refers to a value obtained as follows: the glass substrate is pulverized; then glass powder that passes through a standard 30-mesh sieve (sieve opening: 500 μm) and remains on a 50-mesh sieve (sieve opening: 300 μm) is placed in a platinum boat and kept for 24 hours in a gradient heating furnace; and a temperature at which a crystal is deposited is measured.

In the tempered glass according to the embodiment of the present invention, it is preferred that the tempered glass have a liquidus viscosity of 10^{4.0} dPa·s or more. Herein, the “liquidus viscosity” refers to a value obtained by measuring the viscosity of a glass at the liquidus temperature by a platinum sphere pull up method.

In the tempered glass according to the embodiment of the present invention, it is preferred that the tempered glass have a thermal expansion coefficient of from 50×10⁻⁷/° C. to 110×10⁻⁷/° C. Herein, the “thermal expansion coefficient” refers to a value measured by using a dilatometer and shows an average value in the temperature range of from 30° C. to 380° C.

A tempered glass according to one embodiment of the present invention is a tempered glass having a compressive stress layer in a surface thereof, wherein: the tempered glass is substantially free of Li₂O in a glass composition; the tempered glass has a softening point of 720° C. or less; and the compressive stress layer has a compressive stress value CS of 500 MPa or more and a depth of layer DOL of 20 μm or more. Herein, the “substantially free of Li₂O” refers to the case where the content of Li₂O is less than 0.1 mass % in the glass composition.

A glass to be tempered according to one embodiment of the present invention comprises as a glass composition, in terms of mass %, 45% to 75% of SiO₂, 10% to 30% of Al₂O₃, 0% to 20% of B₂O₃, and 10% to 25% of Na₂O.

In the glass to be tempered according to the embodiment of the present invention, it is preferred that the glass to be tempered have a bent portion and/or a curved portion.

In the glass to be tempered according to the embodiment of the present invention, it is preferred that an end surface of the glass to be tempered be ground and/or polished.

A method of manufacturing a tempered glass according to one embodiment of the present invention comprises: subjecting a glass to be tempered to thermal processing; and then subjecting the glass to be tempered to tempering treatment, to thereby obtain a tempered glass.

In the method of manufacturing a tempered glass according to the embodiment of the present invention, it is preferred that the glass to be tempered comprise as a glass composition, in terms of mass %, 45% to 75% of SiO₂, 10% to 30% of Al₂O₃, 0% to 20% of B₂O₃, and 10% to 25% of Na₂O.

In the method of manufacturing a tempered glass according to the embodiment of the present invention, it is preferred that the tempered glass have a bent portion and/or a curved portion.

In the method of manufacturing a tempered glass according to the embodiment of the present invention, it is preferred that the method further comprise a step of grinding and/or polishing an end surface before the subjecting the glass to be tempered to tempering treatment.

In the method of manufacturing a tempered glass according to the embodiment of the present invention, it is preferred that the method further comprise a step of grinding and/or polishing an end surface after the subjecting the glass to be tempered to tempering treatment.

### BRIEF DESCRIPTION OF DRAWINGS

FIG. 1a is a perspective view for illustrating a tempered glass according to one embodiment of the present invention.

FIG. 1b is a perspective view for illustrating a tempered glass according to one embodiment of the present invention.

FIG. 1c is a perspective view for illustrating a tempered glass according to one embodiment of the present invention.

FIG. 1d is a perspective view for illustrating a tempered glass according to one embodiment of the present invention.

FIG. 1e is a perspective view for illustrating a tempered glass according to one embodiment of the present invention.

FIG. 2a is a perspective view for illustrating a tempered glass according to one embodiment of the present invention.

FIG. 2b is a perspective view for illustrating a tempered glass according to one embodiment of the present invention.

FIG. 2c is a perspective view for illustrating a tempered glass according to one embodiment of the present invention.

FIG. 3a is a schematic front view for illustrating a tempered glass according to one embodiment of the present invention.

FIG. 3b is a schematic side view for illustrating a tempered glass according to one embodiment of the present invention.

FIG. 3c is a schematic plan view for illustrating a tempered glass according to one embodiment of the present invention.

FIG. 4a is a schematic front view for illustrating a tempered glass according to one embodiment of the present invention.

FIG. 4b is a schematic side view for illustrating a tempered glass according to one embodiment of the present invention.

FIG. 4c is a schematic plan view for illustrating a tempered glass according to one embodiment of the present invention.

FIG. 5 is a perspective view for illustrating a tempered glass according to one embodiment of the present invention.

FIG. 6 is a schematic longitudinal sectional side view for illustrating thermal processing according to [Example 3].

FIG. 7 is a step flow chart for illustrating the thermal processing according to [Example 3].

### DESCRIPTION OF EMBODIMENTS

A method of forming a compressive stress layer on the surface of a glass includes a physical tempering method and a chemical tempering method. In the tempered glass of the present invention, a compressive stress layer is preferably formed by a chemical tempering method. The chemical tempering method is a method involving introducing an alkali ion having a large ion radius into the surface of a glass by ion exchange at a temperature equal to or less than a strain point. When the chemical tempering method is adopted, tempering treatment can be performed even when the thickness of the glass is small, and desired mechanical strength can be obtained. Further, when a compressive stress layer is formed by the chemical tempering method, a glass substrate is not broken easily even when the glass substrate is cut after the tempering treatment, which is different from the case of a physical tempering method, such as an air cooling tempering method.

The tempered glass of the present invention comprises, as a glass composition, in terms of mass %, 45% to 75% of SiO₂, 10% to 30% of Al₂O₃, 0% to 20% of B₂O₃, and 10% to 25% of Na₂O. The reasons why the contents of the components are restricted within the above-mentioned ranges are described below. It should be noted that, in the descriptions of the ranges of the contents of the components, the expression “%” represents “mass %” unless otherwise stated.

SiO₂ is a component which forms a network of a glass. The content of SiO₂ is from 50% to 70%, preferably from 53% to 70%, more preferably from 55% to 65%, still more preferably from 55% to 63%, particularly preferably from 55% to 60%. When the content of SiO₂ is too small, vitrification does not easily occur. In addition, the thermal expansion coefficient excessively increases, with the result that the thermal shock resistance is liable to lower. On the other hand, when the content of SiO₂ is too large, the meltability and formability of the glass decrease. In addition, the thermal expansion coefficient becomes too small, with the result that it becomes difficult to match the thermal expansion coefficient with those of peripheral materials.

Al₂O₃ is a component which enhances the ion exchange performance, and is also a component which increases the strain point and the Young's modulus. The content of Al₂O₃ is from 10% to 30%. When the content of Al₂O₃ is too small, the ion exchange performance may not be sufficiently exhibited. On the other hand, when the content of Al₂O₃ is too large, a devitrified crystal is liable to deposit in the glass, and the formability is liable to lower, and in particular, it becomes difficult to form the glass substrate by an overflow down-draw method or the like. In addition, when the content of Al₂O₃ is too large, the thermal expansion coefficient excessively lowers, with the result that it becomes difficult to match the thermal expansion coefficient with those of peripheral materials. In addition, the viscosity at high temperature excessively increases, with the result that it becomes difficult to melt the glass. Further, when the content of Al₂O₃ is too large, owing to an increase in softening point, the temperature for thermal processing excessively increases, and in particular, the temperature at the time of the press molding excessively increases. Therefore, the deterioration of a mold may be promoted. Comprehensively judging the above-mentioned viewpoints, the upper limit range of the content of Al₂O₃ is suitably 19% or less, 18% or less, or 17% or less, particularly suitably 16.5% or less. The lower limit range of the content of Al₂O₃ is suitably 11% or more, or 12% or more, particularly suitably 13% or more.

B₂O₃ is a component which lowers the softening point, and is also a component which lowers a liquidus temperature, a viscosity at high temperature, and a density. The content of B₂O₃ is from 0% to 10%. When the content of B₂O₃ is too large, there are risks in that weathering occurs on the surface through ion exchange, water resistance lowers, a compressive stress value CS lowers, a depth of layer DOL is shortened, and a liquidus viscosity lowers. Therefore, the upper limit range of the content of B₂O₃ is 10% or less, preferably 9% or less or 8% or less, particularly preferably 7% or less. It should be noted that, when the content of B₂O₃ is too small, it becomes difficult to lower the softening point. Therefore, the lower limit range of the content of B₂O₃ is preferably 0.1% or more, 1% or more, 2% or more, 3% or more, or 4% or more, particularly preferably 5% or more.

Na₂O is a component which enhances the ion exchange performance, and is also a component which lowers the viscosity at high temperature to enhance the meltability and the formability. Further, Na₂O is a component which improves devitrification resistance. The content of Na₂O is from 10% to 20%, preferably from 10% to 18%, from 12% to 18%, or from 13% to 17%, particularly preferably from 12% to 15%. When the content of Na₂O is too small, the meltability lowers, the thermal expansion coefficient excessively lowers, the softening point excessively increases, and the ion exchange performance is liable to lower. On the other hand, when the content of Na₂O is too large, the thermal expansion coefficient excessively increases, with the result that the thermal shock resistance lowers and it becomes difficult to match the thermal expansion coefficient with those of peripheral materials. In addition, when the content of Na₂O is too large, there is a tendency that the strain point lowers and a component balance of the glass composition is lost, with the result that the devitrification resistance lowers contrarily.

The content of Al₂O₃+B₂O₃+Na₂O is preferably 18% or more, 19% or more, 20% or more, 21% or more, 22% or more, 23% or more, or 24% or more, particularly preferably 25% or more. With this, both the ion exchange performance and thermal processability are easily achieved. Herein, the “content of Al₂O₃+B₂O₃+Na₂O” refers to the total content of Al₂O₃, B₂O₃, and Na₂O.

The mass ratio Al₂O₃/Na₂O is preferably from 0.75 to 2, from 0.85 to 1.7, or from 0.9 to 1.5, particularly preferably from 0.95 to 1.3. In addition, the mass ratio (Al₂O₃+B₂O₃)/(B₂O₃+Na₂O) is preferably from 0.75 to 2, from 0.85 to 1.7, or from 0.9 to 1.5, particularly preferably from 0.95 to 1.3. With this, both the ion exchange performance and the thermal processability are easily achieved. Herein, the “content of Al₂O₃+B₂O₃+Na₂O” refers to the total content of Al₂O₃, B₂O₃, and Na₂O. Herein, the “Al₂O₃+B₂O₃” refers to the total content of Al₂O₃ and B₂O₃, and the “B₂O₃+Na₂O” refers to the total content of B₂O₃ and Na₂O.

In addition to the above-mentioned components, for example, the following components may be introduced.

Li₂O is a component which enhances the ion exchange performance, and is also a component which lowers the viscosity at high temperature to improve the meltability and the formability. In addition, Li₂O is a component which increases the Young's modulus Further, Li₂O has a large increasing effect on the compressive stress value CS among alkali metal oxides. However, when the content of Li₂O is too large, the liquidus viscosity lowers and the glass is liable to be devitrified. In addition, the thermal expansion coefficient excessively increases, with the result that the thermal shock resistance lowers and it becomes difficult to match the thermal expansion coefficient with those of peripheral materials. Further, when the content of Li₂O is too large, the viscosity at low temperature, in particular, the strain point excessively lowers, with the result that stress relaxation easily occurs at the time of ion exchange, and the compressive stress value CS may lower contrarily. Therefore, the content of Li₂O is preferably from 0% to 10%, from 0% to 8%, from 0% to 6%, from 0% to 4%, from 0% to 3%, from 0% to 2%, from 0% to 1%, or from 0% to 0.5%, particularly preferably from 0% to 0.1%, and it is desired that the glass be substantially free of Li₂O.

K₂O is a component which enhances the ion exchange performance, and is also a component which has a high increasing effect on the depth of layer DOL among alkali metal oxides. In addition, K₂O is a component which lowers the viscosity at high temperature to enhance the meltability and the formability. Further, K₂O is a component which improves the devitrification resistance. However, when the content of K₂O is too large, the thermal expansion coefficient excessively increases, with the result that the thermal shock resistance lowers and it becomes difficult to match the thermal expansion coefficient with those of peripheral materials. In addition, when the content of K₂O is too large, there is a tendency that the strain point lowers, and a component balance of the glass composition is lost, with the result that the devitrification resistance lowers contrarily. From the viewpoints described above, the content of K₂O is preferably from 0% to 10%. The upper limit range of the content of K₂O is suitably 8% or less, 7% or less, or 6% or less, particularly suitably 5% or less. From the viewpoint of increasing the depth of layer DOL, the lower limit range of the content of K₂O is suitably 0.1% or more, 0.5% or more, or 1% or more, particularly suitably 2% or more.

Li₂O+Na₂O+K₂O is a component which enhances the ion exchange performance, and is also a component which lowers the viscosity at high temperature to enhance the meltability and the formability. When the content of Li₂O+Na₂O+K₂O is too small, the ion exchange performance and the meltability may lower, and the softening point may become unreasonably high. Therefore, the content of Li₂O+Na₂O+K₂O is preferably 8% or more, 10% or more, or 13% or more, particularly preferably 15% or more . On the other hand, when the content of Li₂O+Na₂O+K₂O is too large, the glass is liable to be devitrified. In addition, the thermal expansion coefficient excessively increases, with the result that the thermal shock resistance lowers and it becomes difficult to match the thermal expansion coefficient with those of peripheral materials. In addition, the strain point excessively lowers, with the result that the compressive stress value CS may be hardly increased. Further, the viscosity at around the liquidus temperature lowers, with the result that it may become difficult to ensure a high liquidus viscosity. Therefore, the content of Li₂O+Na₂O+K₂O is preferably 30% or less, or 25% or less, particularly preferably 20% or less. It should be noted that the “content of Li₂O+Na₂O+K₂O” refers to the total content of Li₂O, Na₂O, and K₂O.

MgO is a component which lowers the viscosity at high temperature to enhance the meltability and the formability or to increase the strain point and the Young's modulus. In particular, MgO is a component which has a large enhancing effect on the ion exchange performance among alkaline earth metal oxides. The content of MgO is preferably from 0% to 10%, from 0% to 6%, or from 0% to 4%, particularly preferably from 0% to 3%. However, when the content of MgO is too large, the density and the thermal expansion coefficient excessively increase, and the glass is liable to be devitrified.

CaO is a component which lowers the viscosity at high temperature to enhance the meltability and the formability or to increase the strain point and the Young's modulus. CaO is also a component which has a relatively large enhancing effect on the ion exchange performance among alkaline earth metal oxides. However, when the content of CaO is too large, the density and the thermal expansion coefficient excessively increase, the glass is liable to be devitrified, and the component balance of the glass composition is lost, and the ion exchange performance may lower contrarily. Therefore, the content of CaO is preferably from 0% to 10%, from 0% to 3%, from 0% to 1%, or from 0% to less than 0.5%, particularly preferably from 0% to 0.1%.

SrO is a component which lowers the viscosity at high temperature to enhance the meltability and the formability or to increase the strain point and the Young's modulus. When the content of SrO is too large, the ion exchange performance and the devitrification resistance lower. Besides, the density and the thermal expansion coefficient excessively increase. Therefore, the content of SrO is preferably 5% or less, 3% or less, 2% or less, 1% or less, or 0.5% or less, particularly preferably 0.1% or less.

BaO is a component which lowers the viscosity at high temperature to enhance the meltability and the formability or to increase the strain point and the Young's modulus. When the content of BaO is too large, the ion exchange performance and the devitrification resistance lower. Besides, the density and the thermal expansion coefficient excessively increase. Therefore, the content of BaO is preferably 5% or less, 3% or less, 2% or less, 1% or less, 0.8% or less, or 0.5% or less, particularly preferably 0.1% or less.

The content of SrO+BaO is preferably from 0% to 5%, from 0% to 3%, from 0% to 2.5%, from 0% to 2%, or from 0% to 1%, particularly preferably from 0% to 0.1%. SrO and BaO has an inhibiting action on an ion exchange reaction. Therefore, when the content of SrO+BaO is too large, the mechanical strength of the tempered glass is hardly increased. It should be noted that the “content of SrO+BaO” refers to the total content of SrO and BaO.

MgO+CaO+SrO+BaO is a component which lowers the viscosity at high temperature to enhance the meltability and formability or to increase the strain point and the Young's modulus. However, when the content of MgO+CaO+SrO+BaO is too large, there is a tendency that the density and the thermal expansion coefficient excessively increase, the devitrification resistance lowers, and the ion exchange performance lowers. Therefore, the content of MgO+CaO+SrO+BaO is preferably from 0% to 15%, from 0% to 10%, or from 0% to 6%, particularly preferably from 0% to 5%. It should be noted that the “content of MgO+CaO+SrO+BaO” refers to the total content of MgO, CaO, SrO, and BaO.

When a value obtained by dividing the content of MgO+CaO+SrO+BaO by the content of Li₂O+Na₂O+K₂O, that is, a mass fraction (MgO+CaO+SrO+BaO)/(Li₂O+Na₂O+K₂O) is too large, there is a tendency that the devitrification resistance lowers. Therefore, the mass fraction (MgO+CaO+SrO+BaO)/(Li₂O+Na₂O+K₂O) is preferably 0.5 or less, or 0.4 or less, particularly preferably 0.3 or less.

ZnO is a component which enhances the ion exchange performance. In particular, ZnO is a component which increases the compressive stress value CS. Further, ZnO is a component which lowers the viscosity at high temperature without lowering the viscosity at low temperature. However, when the content of ZnO is too large, the glass manifests phase separation, the devitrification resistance lowers, and the density is liable to increase. The content of ZnO is preferably from 0% to 10%, from 0% to 5%, or from 0% to 3%, particularly preferably from 0% to 1%.

ZrO₂ is a component which markedly enhances the ion exchange performance, and is also a component which increases the viscosity around the liquidus viscosity and the strain point. However, when the content of ZrO₂ is too large, the devitrification resistance may excessively lower. Therefore, the content of ZrO₂ is preferably from 0% to 10%, from 0% to 9%, from 0% to 5%, from 0% to 3%, or from 0% to 1%, particularly preferably from 0% to 0.1%.

TiO₂ is a component which enhances the ion exchange performance, and is also a component which lowers the viscosity at high temperature. However, when the content of TiO₂ is too large, the glass is colored and the devitrification resistance is liable to lower. Therefore, the content of TiO₂ is preferably 1% or less or 0.5% or less, particularly preferably 0.1% or less.

P₂O₃ is a component which enhances the ion exchange performance. In particular, P₂O₃ is a component which increases the depth of layer DOL. However, when the content of P₂O₃ is too large, the glass manifests phase separation and the water resistance is liable to lower. Therefore, the content of P₂O₃ is preferably 8% or less, 5% or less, 4% or less, 2% or less, 1% or less, 0.5% or less, or 0.2% or less, particularly preferably 0.1% or less.

As a fining agent, one kind or two or more kinds selected from the group consisting of As₂O₃, Sb₂O₃, CeO₂, SnO₂, F, Cl, and SO₃ may be introduced in an amount of from 0% to 3%. It should be noted that it is preferred to use As₂O₃, Sb₂O₃, and F, in particular, As₂O₃ and Sb₂O₃ in an amount as small as possible from the environmental viewpoints, and each content thereof is preferably less than 0.1%. The fining agent is preferably one kind or two or more kinds selected from the group consisting of SnO₂, SO₃, and Cl, particularly preferably SnO₂. The content of SnO₂ is preferably from 0% to 1% or from 0.01% to 0.5%, particularly preferably from 0.05% to 0.4%. When the content of SnO₂ is too large, the devitrification resistance is liable to lower. The content of SO₃ is preferably from 0% to 0.1%, from 0.0001% to 0.1%, from 0.0003% to 0.08%, or from 0.0005% to 0.05%, particularly preferably from 0.001% to 0.03%. When the content of SO₃ is too large, SO₃ reboils at the time of melting, with the result that bubble quality is liable to lower. The content of Cl is preferably from 0% to 0.5%, from 0.001% to 0.1%, from 0.001% to 0.09%, or from 0.001% to 0.05%, particularly preferably from 0.001% to 0.03%. When the content of Cl is too large, metal wiring is liable to be eroded at the time of forming a metal wiring pattern or the like on the tempered glass.

Rare earth oxides, such as Nd₂O₃ and La₂O₃, are components which increase the Young's modulus. However, the cost of the raw material itself is high, and when the rare earth oxides are contained in a large amount, the devitrification resistance is liable to lower. Therefore, the content of the rare earth oxides is preferably 3% or less, 2% or less, 1% or less, or 0.5% or less, particularly preferably 0.1% or less in terms of a total content.

Transition metal oxides, such as CoO₃ and NiO, are components which cause intense coloration of glass to lower a transmittance. Therefore, the content of the transition metal oxides is preferably 0.5% or less or 0.1% or less, particularly preferably 0.05% or less in terms of a total content. It is desired to control the amount of impurities in raw materials and/or cullet of the glass so that the content of the transition metal oxides falls within such range.

It is preferred to use PbO and Bi₂O₃ in an amount as small as possible from the environmental viewpoints, and the content thereof is preferably less than 0.1%.

In addition to the above-mentioned components, another component maybe introduced. The introduction amount of the other component is preferably 5% or less, particularly preferably 3% or less.

The suitable content range of each component may be appropriately selected and used as a preferred glass composition range. In particular, the following glass composition ranges are preferred:

(1) a glass composition comprising, in terms of mass %, 45% to 75% of SiO₂, 10% to 30% of Al₂O₃, 2% to 20% of B₂O₃, and 10% to 20% of Na₂O;

(2) a glass composition comprising, in terms of mass %, 45% to 60% of SiO₂, 10% to 20% of Al₂O₃, 2% to 10% of B₂O₃, and 12% to 20% of Na₂O;

(3) a glass composition comprising, in terms of mass %, 50% to 60% of SiO₂, 12% to 20% of Al₂O₃, 3% to 10% of B₂O₃, and 11% to 20% of Na₂O; and

(4) a glass composition comprising, in terms of mass %, 55% to 60% of SiO₂, 12% to 17% of Al₂O₃, 4% to 10% of B₂O₃, and 12% to 20% of Na₂O.

In the tempered glass of the present invention, the compressive stress layer has a compressive stress value CS of preferably 50 MPa or more, 100 MPa or more, 300 MPa or more, 500 MPa or more, or 600 MPa or more, particularly preferably 700 MPa or more. As the compressive stress value CS becomes higher, the mechanical strength of the tempered glass becomes higher. However, when an excessively large compressive stress is formed in the surface, micro cracks are generated on the surface, and the mechanical strength of the tempered glass may lower contrarily. In addition, such formation of an excessively large compressive stress in the surface may cause an excessively high internal tensile stress. Therefore, the compressive stress value CS is preferably 1,300 MPa or less. It should be noted that the compressive stress value CS may be increased by increasing the content of Al₂O₃, TiO₂, ZrO₂, MgO, or ZnO in the glass composition, reducing the content of SrO or BaO, shortening the ion exchange time, or reducing the ion exchange temperature.

When the tempered glass is mounted on a touch panel, end users have increased chances of touching the surface of the tempered glass with their fingers, and hence the mechanical strength of the tempered glass is liable to lower owing to a flaw on the surface and the like. Therefore, in order to maintain the mechanical strength of the tempered glass, it is effective that the depth of layer DOL be increased. In the tempered glass of the present invention, the depth of layer DOL is preferably 10 μm or more, 20 μm or more, 30 μm or more, 40 μm or more, or 50 μm or more, particularly preferably 60 μm or more. As the depth of layer DOL becomes larger, the tempered glass is less liable to be broken even when the tempered glass has a deep flaw. However, when the depth of layer DOL is too large, cutting processing of the tempered glass becomes difficult. Therefore, the depth of layer DOL is preferably 200 μm or less or 100 μm or less, particularly preferably less than 80 μm. It should be noted that the depth of layer DOL may be increased by increasing the content of Al₂O₃, K₂O, TiO₂, ZrO₂, MgO, or ZnO in the glass composition, reducing the content of SrO or BaO, prolonging the ion exchange time, or increasing the ion exchange temperature.

In the tempered glass of the present invention, an internal tensile stress value CT calculated based on the following mathematical formula 1 is preferably 200 MPa or less, 150 MPa or less, or 100 MPa or less, particularly preferably 50 MPa or less. As the internal tensile stress value CT becomes smaller, the probability that the tempered glass is broken owing to an internal defect becomes lower. However, when the internal tensile stress value CT is extremely small, the compressive stress value CS and the depth of layer DOL are liable to lower excessively. Therefore, the internal tensile stress value CT is preferably 1 MPa or more or 10 MPa or more, particularly preferably 15 MPa or more.

CT=(CS×DOL)/(thickness of tempered glass-DOL×2)

The density of the tempered glass of the present invention is preferably 2.52 g/cm³ or less, 2.50 g/cm³ or less, 2.49 g/cm³ or less, or 2.48 g/cm³ or less, particularly preferably 2.45 g/cm³ or less. As the density becomes lower, the weight of the glass can be made lighter. The density may be reduced by increasing the content of SiO₂, P₂O₅, or B₂O₃ in the glass composition or reducing the content of an alkali metal oxide, an alkaline earth metal oxide, ZnO, ZrO₂, or TiO₂ in the glass composition. It should be noted that the “density” refers to a value measured by a well-known Archimedes method.

The strain point is preferably 400° C. or more, 420° C. or more, or 450° C. or more, particularly preferably 480° C. or more. As the strain point becomes higher, the heat resistance is improved more, and even when the tempered glass is subjected to heat treatment, the compressive stress layer is less liable to disappear. In addition, when the strain point is high, stress relaxation hardly occurs at the time of ion exchange, and hence a high compressive stress value CS can be easily obtained. Further, when the strain point is high, a temperature-lowering rate can be increased during a temperature-lowering process after thermal processing. As a result, the process time of the thermal processing is shortened and the productivity of the tempered glass is improved. It should be noted that the strain point may be increased by reducing the content of an alkali metal oxide in the glass composition, in particular, reducing the content of Li₂O in the glass composition or increasing the content of an alkaline earth metal oxide, Al₂O₃, ZrO₂, or P₂O₃ in the glass composition.

The softening point is preferably 800° C. or less, 780° C. or less, 750° C. or less, 720° C. or less, or 700° C. or less, particularly preferably 690° C. or less. As the softening point becomes lower, the thermal processing can be performed at lower temperature. As a result, the annealing time and cooling time after the thermal processing can be shortened. In addition, as the softening point becomes lower, burden on a mold becomes smaller when press molding is performed. Deterioration of a mold is often caused by a reaction between a metal material to be used for a mold and oxygen in the air, that is, an oxidation reaction. Such oxidation reaction allows the formation of a reaction product on the surface of the mold. As a result, press molding does not provide a predetermined shape in some cases. In addition, when the oxidation reaction occurs, ions in the glass are reduced to produce bubbles in some cases. The degree of the oxidation reaction varies depending on the press molding temperature or the softening point. As the press molding temperature and the softening point become lower, the oxidation reaction can be suppressed more.

The temperature at a viscosity at high temperature of 10^{2.5} dPa·s is preferably 1,600° C. or less, 1,550° C. or less, 1,500° C. or less, 1,450° C. or less, 1,430° C. or less, or 1,420° C. or less, particularly preferably 1,400° C. or less. When the temperature at 10^{2.5} dPa·s becomes lower, at the time of melting, burden on a production facility, such as a melting furnace, becomes smaller, and the bubble quality can be improved more. That is, when the temperature at 10^{2.5} dPa·s becomes lower, the glass can be produced at lower cost. It should be noted that the temperature at 10^{2.5} dPa·s corresponds to the melting temperature, and when the temperature at a viscosity at high temperature of 10^{2.5} dPa·s becomes lower, the glass can be melted at lower temperature. The temperature at 10^{2.5} dPa·s may be reduced by increasing the content of an alkali metal oxide, an alkaline earth metal oxide, ZnO, B₂O₃, or TiO₂ or reducing the content of SiO₂ or Al₂O₃. It should be noted that the “temperature at 10^{2.5} dPa·s” refers to a value measured by a platinum sphere pull up method.

The thermal expansion coefficient is preferably from 50×10⁻⁷/° C. to 110×10⁻⁷/° C., from 70×10⁻⁷/° C. to 110×10⁻⁷/° C., or from 75×10⁻⁷/° C. to 105×10⁻⁷/° C., particularly preferably from 80×10⁻⁷/° C. to 105×10⁻⁷/° C. When the thermal expansion coefficient falls within the above-mentioned range, it becomes easy to match the thermal expansion coefficient with that of a peripheral member, such as a metal or an organic adhesive, thereby making it possible to prevent the separation of the peripheral member. It should be noted that the thermal expansion coefficient is increased when the content of an alkali metal oxide or an alkaline earth metal oxide in the glass composition is increased, whereas the thermal expansion coefficient is reduced when the content of an alkali metal oxide or an alkaline earth metal oxide in the glass composition is reduced.

The liquidus temperature is preferably 1,200° C. or less, 1,050° C. or less, 1,000° C. or less, 950° C. or less, or 900° C. or less, particularly preferably 860° C. or less. The liquidus temperature may be reduced by increasing the content of Na₂O, K₂O, or B₂O₃ in the glass composition or reducing the content of Al₂O₃, Li₂O, MgO, ZnO, TiO₂, or ZrO₂ in the glass composition.

The liquidus viscosity is preferably 10^{4.0} dPa·s or more, 10^{4.5} dPa·s or more, 10^{5.0} dPa·s or more, 10^{5.2} dPa·s or more, 10^{5.3} dPa·s or more, 10^{5.5} dPa·s or more, 10^{5.7} dPa·s or more, or 10^{5.8} dPa·s or more, particularly preferably 10^{6.0} dPa·s or more. The liquidus viscosity may be increased by increasing the content of Na₂O or K₂O in the glass composition or reducing the content of Al₂O₃, Li₂O, MgO, ZnO, TiO₂, or ZrO₂. It should be noted that as the liquidus viscosity becomes higher, the devitrification resistance is improved more. In addition, as the liquidus temperature becomes lower, the the devitrification resistance is improved more. That is, as the liquidus viscosity becomes higher or the liquidus temperature becomes lower, the precipitation of crystals from the glass becomes more difficult. Therefore, even when the thermal processing is performed at low temperature, a defect due to devitrification hardly occurs.

When the tempered glass is used as an exterior part or the like, the thickness of the tempered glass is preferably 0.3 mm or more, 0.5 mm or more, 0.7 mm or more, 1.0 mm or more, or 1.3 mm or more, particularly preferably 1.5 mm or more. With this, the mechanical strength of the tempered glass can be maintained. Meanwhile, when the tempered glass is used as a substrate or the like or when the thermal processability is to be enhanced, the thickness of the tempered glass is preferably 3.0 mm or less, 1.5 mm or less, 0.7 mm or less, or 0.5 mm or less, particularly preferably 0.3 mm or less. It should be noted that as the thickness of the tempered glass becomes smaller, the weight of the tempered glass can be reduced more.

It is preferred that the tempered glass of the present invention have an unpolished surface. It is particularly preferred that the entire effective surface except end edge areas be unpolished. In addition, the average surface roughness (Ra) of the unpolished surface is preferably 10 Å or less or 5 Å or less, particularly preferably 2 Å or less. With this, when the tempered glass is used as an exterior part, an appropriate gloss may be imparted to the tempered glass. The theoretical strength of glass is inherently very high, but glass is broken even with a much lower stress than the theoretical strength in many cases. This is because a small defect called “Griffith flow” is produced on the surface of the glass in the step after the forming of molten glass, for example, in the polishing step. Therefore, when the surface is unpolished, the inherent mechanical strength of the glass is hardly impaired, and the glass is hardly broken. In addition, when the surface is unpolished, the polishing step can be eliminated, thereby making it possible to reduce the production cost of the tempered glass. It should be noted that the cut surface is preferably subjected to chamfering processing or the like in order to prevent a situation in which the glass is broken from the cut surface. An unpolished glass substrate having high surface accuracy can be obtained when the molten glass is formed by an overflow down-draw method. Herein, the “average surface roughness (Ra) ” refers to a value measured by a method in conformity with SEMI D7-97 “FPD Glass Substrate Surface Roughness Measurement Method.”

The tempered glass of the present invention preferably has a bent portion and/or a curved portion. With this, the design property of an exterior part or the like can be improved.

The bent portion is formed preferably in at least one end edge area of the tempered glass having a rectangular shape, more preferably in opposing end edge areas, still more preferably in the entire end edge areas. With this, in the case where the tempered glass is used as an exterior part or the like, its end surface is less liable to be exposed to the outside, and the tempered glass is less liable to be broken from the end surface by a physical impact.

The tempered glass of the present invention preferably has a flat sheet portion and the bent portion. With this, in the case where the tempered glass is used as an exterior part or the like, the flat sheet portion is allowed to correspond to an operating area of a touch panel, and the surface of the bent portion (excluding the end surface) is allowed to correspond to an external side surface. In addition, in the case of allowing the surface of the bent portion (excluding the end surface) to correspond to the external side surface, the end surface is less liable to be exposed to the outside, and the tempered glass is less liable to be broken from the end surface by a physical impact.

The curved portion is preferably formed in the overall width direction of the tempered glass or in the overall length direction, which is perpendicular to the width direction. The curved portion is more preferably formed in the overall width direction and in the overall length direction of the tempered glass. With this, a stress is less liable to be concentrated in a specific portion, and in the case where the tempered glass is used as an exterior part or the like, the tempered glass is less liable to be broken by a physical impact. It should be noted that, in the case of forming the curved portion in the overall width direction and in the overall length direction, it is preferred to set the degree of curve in the width direction and the degree of curve in the length direction to differ from each other. With this, the design property of the exterior part or the like can be improved.

The tempered glass of the present invention preferably has a protrusion on the flat sheet portion. With this, the design property of the tempered glass can be improved.

The tempered glass of the present invention is preferably obtained through thermal processing. With this, the bent portion and/or the curved portion can be easily formed. The thermal processing is preferably performed before tempering treatment. With this, a situation in which the compressive stress is reduced through the thermal processing can be prevented.

The temperature of the thermal processing is preferably (annealing point −10° C.) or more, (annealing point −5° C.) or more, or (annealing point +5° C.) or more, particularly preferably (annealing point +20° C.) or more. With this, the thermal processing can be performed in a short time. On the other hand, the temperature of the thermal processing is preferably (softening point −5° C.) or less, (softening point −15° C.) or less, or (softening point −20° C.) or less, particularly preferably (softening point −30° C.) or less. With this, surface smoothness is less liable to be impaired through the thermal processing, and dimensional accuracy after the thermal processing can be improved as well.

An end surface of the tempered glass of the present invention is preferably subjected to grinding and/or polishing. With this, in the case where the tempered glass is used as an exterior part or the like, the end surface can be formed into a shape difficult to be exposed to the outside.

The end surface of the tempered glass of the present invention is preferably subjected to grinding and/or polishing before the thermal processing. In the grinding and/or polishing of the end surface before the thermal processing, the end surface is preferably subjected to chamfering processing. In addition, a chamfered shape is preferably set to an R chamfered shape (curved shape), a C chamfered shape (planar shape), or a light chamfered shape. With this, the strength of the end surface can be increased in a glass to be tempered and the tempered glass.

It is also preferred that the end surface of the tempered glass of the present invention be subjected to grinding and/or polishing after the thermal processing and before the tempering treatment. With this, in the case where the tempered glass is used as an exterior part or the like, the end surface can be formed into a shape difficult to be exposed to the outside, and besides, a situation in which the compressive stress is reduced through the thermal processing can be prevented.

In the grinding and/or polishing of the end surface after the thermal processing and before the tempering treatment, the count of a polishing material is preferably from #300 to #4000, more preferably from #600 to #2000, still more preferably form #800 to #1500. In addition, it is preferred to gradually increase the count of the polishing material (for example, gradually increase the count in the order of #600, #800, and #1000). With this, the mechanical strength of the end surface can be increased while the speed of the treatment on the end surface is increased.

In the grinding and/or polishing of the end surface after the thermal processing and before the tempering treatment, the end surface is preferably processed while the glass subjected to the thermal processing is placed on or sandwiched in a jig having a shape matching the shape of the glass. The jig to be used is preferably made of a material having a hardness lower than that of the glass (for example, an acrylic resin, bakelite, or the like). With this, a flaw is less liable to occur in the glass subjected to the thermal processing, and the glass is less liable to be broken.

It is also preferred that the end surface of the tempered glass of the present invention be subjected to grinding and/or polishing after the tempering treatment. With this, a dimensional error or the like to be generated after the tempering treatment can be removed through the grinding and/or polishing.

It is preferred to grind and/or polish the end surface of the tempered glass of the present invention after the thermal processing and before the tempering treatment, and then to perform the tempering treatment and further grind and/or polish the end surface. That is, it is preferred that the end surface of the glass subjected to the thermal processing be coarsely ground or the like, and then the glass be subjected to the tempering treatment, and further the end surface be finely polished or the like. With this, the dimensional error or the like to be generated after the tempering treatment can be removed through the grinding and/or polishing while the amount of the compressive stress layer to be removed through the polishing and/or grinding is reduced.

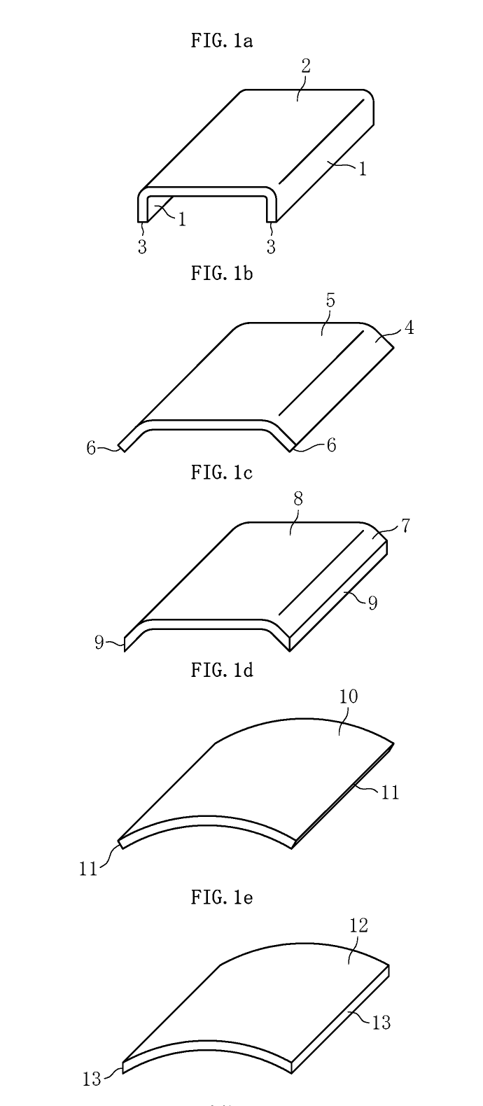

FIG. 1a to FIG. 1e are each a perspective view for illustrating a tempered glass according to one embodiment of the present invention. In FIG. 1a, the tempered glass has bent portions 1 (bend angle: about 90°) in both end edge areas of the tempered glass in a sheet width direction and a flat sheet portion 2 in a central area of the tempered glass. In this case, end surfaces 3 of the bent portions 1 are each a surface perpendicular to the sheet thickness direction of the flat sheet portion 2. In FIG. 1b, the tempered glass has bent portions 4 (bend angle: about 45°) in both end edge areas of the tempered glass in a sheet width direction and a flat sheet portion 5 in a central area of the tempered glass. In this case, end surfaces 6 of the bent portions 4 are each a surface at 45° to the sheet thickness direction of the flat sheet portion 5 (surface perpendicular to the bend direction of the bent portions 4). In FIG. 1c, the tempered glass has bent portions 7 (bend angle: about 45°) in both end edge areas of the tempered glass in a sheet width direction and a flat sheet portion 8 in a central area of the tempered glass. In this case, end surfaces 9 of the bent portions 7 are each a surface along the sheet thickness direction of the flat sheet portion 8. In addition, the end surfaces 9 of the bent portions 7 are preferably formed through grinding and/or polishing after the thermal processing and before the tempering treatment. In FIG. 1d, the tempered glass has a curved portion 10 in which the entire tempered glass is curved in an arc in a sheet width direction, and end surfaces 11 opposite to each other in the sheet width direction are each inclined with respect to a vertical direction depending on the degree of curve. In FIG. 1e, the tempered glass has a curved portion 12 in which the entire tempered glass is curved in an arc in a sheet width direction, and end surfaces 13 opposite to each other in the sheet width direction are each a surface along the vertical direction. In this case, the end surfaces 13 opposite to each other in the sheet width direction are preferably formed through grinding and/or polishing after the thermal processing and before the tempering treatment.

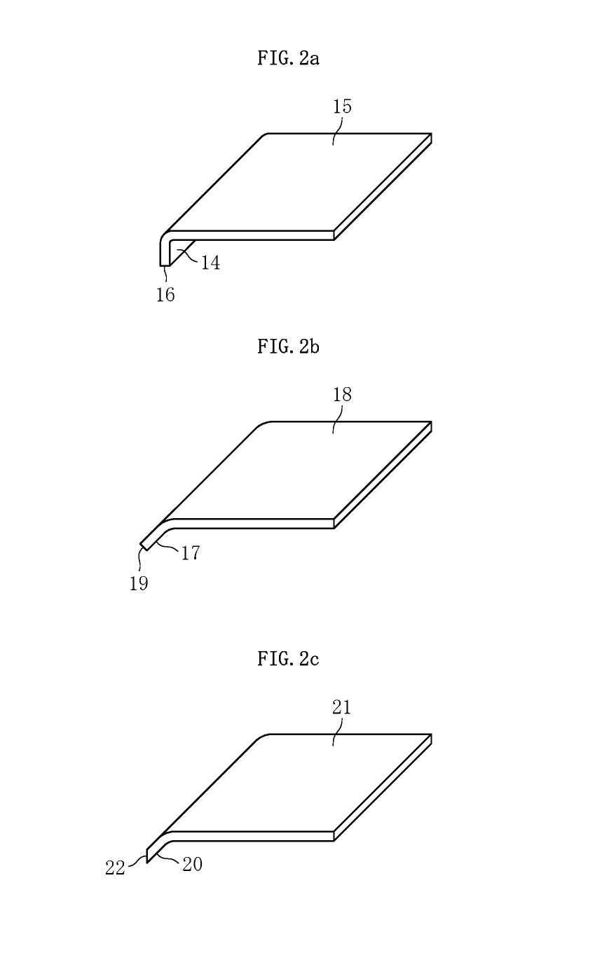

FIG. 2a to FIG. 2c are each a perspective view for illustrating a tempered glass according to one embodiment of the present invention. In FIG. 2a, the tempered glass has a bent portion 14 (bend angle: about 90°) in the left end edge area of the tempered glass in a sheet width direction and a flat sheet portion 15 in the remaining area. In this case, an end surface 16 of the bent portion 14 is a surface at 90° to the sheet thickness direction of the flat sheet portion 15. In FIG. 2b, the tempered glass has a bent portion 17 (bend angle: about 45°) in the left end edge area of the tempered glass in a sheet width direction and a flat sheet portion 18 in the remaining area. In this case, an end surface 19 of the bent portion 17 is a surface at 45° to the sheet thickness direction of the flat sheet portion 18 (surface perpendicular to the bend direction of the bent portion 17). In FIG. 2c, the tempered glass has a bent portion 20 (bend angle: about 45°) in the left end edge area of the tempered glass in a sheet width direction and a flat sheet portion 21 in the remaining area. In this case, an end surface 22 of the bent portion 20 is a surface along the sheet thickness direction of the flat sheet portion 21.

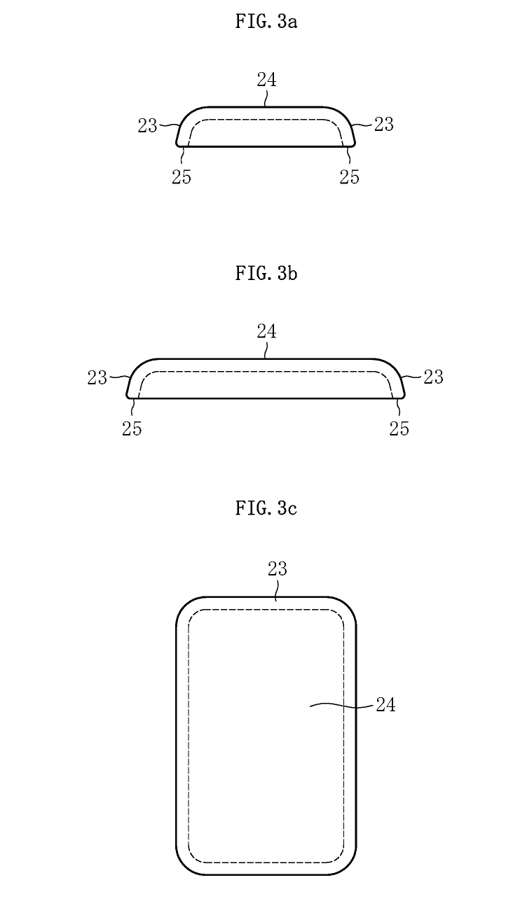

A tempered glass according to one embodiment of the present invention is illustrated in FIG. 3a to FIG. 3c. FIG. 3a to FIG. 3c are schematic views of the tempered glass viewed from three directions. Specifically, FIG. 3a is a front view, FIG. 3b is a side view, and FIG. 3c is a plan view. As is apparent from FIG. 3a to FIG. 3c, bent portions 23 (bend angle: about 75°) are formed in the entire end edge areas of the tempered glass, and a flat sheet portion 24 is formed in a central area of the tempered glass. In this case, end surfaces 25 of the bent portions 23 are each a surface perpendicular to the sheet thickness direction of the flat sheet portion 24.

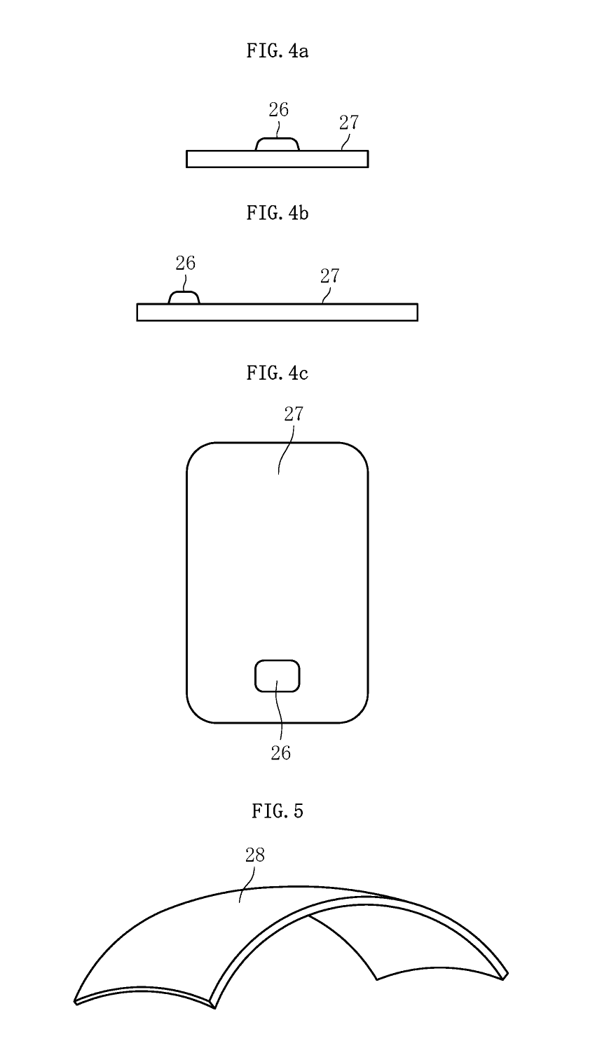

A tempered glass according to one embodiment of the present invention is illustrated in FIG. 4a to FIG. 4c. FIG. 4a to FIG. 4c are schematic views of the tempered glass viewed from three directions. Specifically, FIG. 4a is a front view, FIG. 4b is a side view, and FIG. 4c is a plan view. A protrusion 26 having a rectangular parallelepiped shape (the shape may be a semispherical shape or the like) is formed in an area at a distance from the lower end of the tempered glass in a length direction (longitudinal direction) illustrated in FIG. 4c and in the central portion of the tempered glass in a sheet width direction (in a direction perpendicular to the longitudinal direction) illustrated in FIG. 4a. The protrusion 26 is formed on a flat sheet portion 27, and in this embodiment, the protrusion 26 has a flat top portion.

FIG. 5 is a perspective view for illustrating a tempered glass according to one embodiment of the present invention. As is apparent from FIG. 5, the entire tempered glass is curved in an arc in the sheet width direction thereof and curved in an arc in the length direction thereof to form a curved portion 28. In this case, the degree of curve in the sheet width direction (in a direction perpendicular to the longitudinal direction) is smaller than the degree of curve in the length direction (longitudinal direction).

The tempered glass of the present invention may be produced by placing a glass batch which is prepared to have a predetermined glass composition in a continuous melting furnace, melting the glass batch by heating at from 1,500° C. to 1,600° C., fining the resultant, feeding the resultant to a forming apparatus, and forming the molten glass, and annealing the glass.

In the tempered glass of the present invention, various forming methods may be adopted. For example, there may be adopted forming methods, such as down-draw methods (e.g., an overflow down-draw method, a slot down method, and a re-draw method), a float method, and a roll out method. In addition, the molten glass may be directly formed into a predetermined shape by press forming.

The tempered glass of the present invention is preferably formed into a glass substrate by an overflow down-draw method. With this, a glass substrate which is unpolished and has good surface quality can be produced. This is because in the case of adopting the overflow down-draw method, a surface to be the surface of the glass substrate does not come into contact with a trough-shaped refractory, and is formed in the form of a free surface. Herein, the overflow down-draw method is a method in which a molten glass is allowed to overflow from both sides of a heat-resistant trough-shaped structure, and the overflown molten glasses are down-drawn downwardly while combining them at the lower end of the trough-shaped structure, to thereby produce a glass substrate. The structure and material of the trough-shaped structure are not particularly limited as long as the structure and material provide desired size and surface accuracy of the glass substrate and can realize quality which allows the use as the glass substrate. In addition, any method may be used to apply force to the glass substrate to perform downward down-draw. For example, there may be adopted a method involving rotating a heat-resistant roll having a sufficiently large width in the state of being in contact with the glass substrate, to thereby draw the glass, and a method involving allowing a plurality of pairs of heat-resistant rolls to come into contact with only a vicinity of end surfaces of the glass substrate to thereby draw the glass.

A glass to be tempered of the present invention comprises as a glass composition, in terms of mass o, 45% to 75% of SiO₂, 10% to 30% of Al₂O₃, 0% to 20% of B₂O₃, and 10% to 25% of Na₂O. With this, both the ion exchange performance and the thermal processability can be achieved. In addition, the glass to be tempered of the present invention can be provided with technical features (suitable glass composition range, suitable properties, remarkable effects, and the like) similar to those of the tempered glass of the present invention. The overlapping description of the technical features is omitted herein for convenience.

The tempered glass can be obtained by subjecting the glass to be tempered to the tempering treatment. As described above, the tempering treatment is preferably ion exchange treatment. The ion exchange treatment may be performed by, for example, immersing the glass to be tempered in a KNO₃ molten salt at from 400° C. to 550° C. for from 1 hour to 8 hours. The conditions of the ion exchange treatment maybe optimally selected in consideration of the viscosity characteristics, applications, thickness, internal tensile stress, or the like of the glass.

As already described, the thermal processing is preferably performed on a glass substrate to be tempered before the tempering treatment, and also the grinding and/or polishing of the end surface is preferably performed on the glass substrate to be tempered before the tempering treatment. Further, it is also preferred to perform the grinding and/or polishing of the end surface after the thermal processing in order to remove the dimensional error or the like after the thermal processing.

The thermal processing is preferably performed on a glass substrate to be tempered having a flat sheet shape. In addition, as a preferred thermal processing method, there is given a method involving subjecting the glass substrate to be tempered having a flat sheet shape to press molding with a mold. With this, the dimensional accuracy of the glass to be tempered can be increased after the thermal processing. It should be noted that the protrusion is preferably formed by subjecting molten glass to press molding with a mold.

In addition, as another preferred thermal processing method, there is given a method involving sandwiching the glass substrate to be tempered having a flat sheet shape in a sheet thickness direction at a temperature at which the glass substrate to be tempered does not undergo softening deformation by heat to support the glass substrate to be tempered, to thereby allow elastic deformation of the glass substrate to be tempered into a curved state, and then heating the glass substrate to be tempered, which has been elastically deformed, to obtain a glass to be tempered having a curved portion (in particular, a glass to be tempered having a curved portion in which the entire glass is curved in an arc in the sheet width direction) . By such method, a flaw to be caused on the surface of the glass substrate to be tempered in a portion to be brought into contact with an external material owing to displacement or the like in association with the operation of allowing the elastic deformation can be suitably avoided. As a result, a defect or a flaw can be prevented from remaining on the surface of the curved portion after the forming as much as possible.

In the above-mentioned method, in supporting the glass substrate to be tempered, it is preferred to use a forming mold having a concave curved surface and a convex curved surface facing the concave curved surface, and having formed between the curved surfaces a curve forming space having a thickness larger than that of the glass substrate to be tempered, to sandwich the glass substrate to be tempered therein by two positions on the concave curved surface and one position on the convex curved surface to support the glass substrate to be tempered. With this, the curve forming space having a thickness larger than that of the glass substrate to be tempered is formed between the curved surfaces, and hence excessive pressure can be prevented from acting on the glass substrate to be tempered from the forming mold. In addition, in this method, the glass substrate to be tempered is sandwiched by two positions on the concave curved surface and one position on the convex curved surface to be supported, and hence areas in which the respective curved surfaces are brought into contact with the surface of the glass substrate to be tempered are suppressed to be small. Therefore, a flaw to be caused on the surface of the glass substrate to be tempered can be prevented as much as possible. Further, it is preferred that sheet-shaped heat-resistant members intermediate between the concave curved surface and one surface of the glass substrate to be tempered and between the convex curved surface and the other surface of the glass substrate to be tempered. With this, direct contact between the surfaces of the glass substrate to be tempered and the forming mold can be avoided through intermediation of the sheet-shaped heat-resistant members, and the surfaces of the glass substrate to be tempered are safely protected from occurrence of a defect or a flaw. As a result, a defect or a flaw can be more suitably prevented from remaining on the surface of the curved portion after the forming.

A method of manufacturing a tempered glass of the present invention comprises subjecting a glass to be tempered to thermal processing and then tempering treatment, to obtain a tempered glass. The technical feature of the method of manufacturing a tempered glass of the present invention has already been described in the sections of the “tempered glass” and “glass to be tempered” of the present invention. Therefore, its description is omitted herein for convenience.

### EXAMPLES

### Example 1

Now, the present invention is described in detail based on Examples. It should be noted that the following Examples are merely illustrative. The present invention is by no means limited to the following Examples.

Examples of the present invention (Nos. 1 to 38) are shown in Tables 1 to 6.

TABLE 1

| Glass composition [mass %] | No. 1 | No. 2 | No. 3 | No. 4 | No. 5 | No. 6 | No. 7 |
|---|---|---|---|---|---|---|---|
| SiO₂ | 61.5 | 59.5 | 57.5 | 55.5 | 59.5 | 57.5 | 55.5 |
| Al₂O₃ | 14.0 | 14.0 | 14.0 | 14.0 | 16.0 | 16.0 | 16.0 |
| B₂O₃ | 5.0 | 5.0 | 5.0 | 5.0 | 5.0 | 5.0 | 5.0 |
| Na₂O | 14.0 | 16.0 | 18.0 | 20.0 | 14.0 | 16.0 | 18.0 |
| K₂O | 2.0 | 2.0 | 2.0 | 2.0 | 2.0 | 2.0 | 2.0 |
| MgO | 3.0 | 3.0 | 3.0 | 3.0 | 3.0 | 3.0 | 3.0 |
| SnO₂ | 0.5 | 0.5 | 0.5 | 0.5 | 0.5 | 0.5 | 0.5 |
| Density [g/cm³] | 2.44 | 2.46 | 2.49 | 2.48 | 2.44 | 2.46 | 2.48 |
| Ps [° C.] | 534 | 523 | 498 | 511 | 536 | 524 | 511 |
| Ta [° C.] | 574 | 560 | 533 | 547 | 574 | 561 | 547 |
| Ts [° C.] | 772 | 743 | 696 | 718 | 778 | 745 | 719 |
| 10^{4.0} dPa · s [° C.] | 1,140 | 1,089 | 1,022 | 1,036 | 1,149 | 1,093 | 1,051 |
| 10^{3.0} dPa · s [° C.] | 1,344 | 1,287 | 1,211 | 1,227 | 1,351 | 1,290 | 1,242 |
| 10^{2.5} dPa · s [° C.] | 1,475 | 1,416 | 1,334 | 1,352 | 1,479 | 1,416 | 1,366 |
| α [×10⁻⁷/° C.] | 85 | 93 | 105 | 100 | 89 | 95 | 102 |
| (30° C.-380° C.) | | | | | | | |
| E [GPa] | 71 | 71 | 71 | 71 | 70 | 71 | 71 |
| Specific Young's modulus | 29.0 | 28.9 | 28.5 | 28.7 | 28.8 | 28.8 | 28.6 |
| [GPa/(g/cm³)] | | | | | | | |
| TL [° C.] | 945 | 925 | 900 | 900 | 940 | 905 | 910 |
| Logη at TL [dPa · s] | 5.4 | 5.2 | 4.9 | 5.1 | 5.6 | 5.5 | 5.1 |
| CS [MPa] | 874 | 817 | 618 | 736 | 913 | 851 | 772 |
| DOL [μm] | 24 | 26 | 34 | 30 | 27 | 28 | 32 |

TABLE 2

| Glass composition [mass %] | No. 8 | No. 9 | No. 10 | No. 11 | No. 12 | No. 13 | No. 14 |
|---|---|---|---|---|---|---|---|
| SiO₂ | 53.5 | 59.5 | 57.5 | 55.5 | 53.5 | 57.5 | 55.5 |
| Al₂O₃ | 16.0 | 14.0 | 14.0 | 14.0 | 14.0 | 16.0 | 16.0 |
| MgO | 3.0 | 3.0 | 3.0 | 3.0 | 3.0 | 3.0 | 3.0 |
| B₂O₃ | 5.0 | 7.0 | 7.0 | 7.0 | 7.0 | 7.0 | 7.0 |
| Na₂O | 20.0 | 14.0 | 16.0 | 18.0 | 20.0 | 14.0 | 16.0 |
| K₂O | 2.0 | 2.0 | 2.0 | 2.0 | 2.0 | 2.0 | 2.0 |
| SnO₂ | 0.5 | 0.5 | 0.5 | 0.5 | 0.5 | 0.5 | 0.5 |
| Density [g/cm³] | 2.49 | 2.44 | 2.46 | 2.48 | 2.49 | 2.44 | 2.46 |
| Ps [° C.] | 497 | 526 | 517 | 508 | 496 | 526 | 518 |
| Ta [° C.] | 532 | 563 | 553 | 543 | 530 | 564 | 555 |
| Ts [° C.] | 696 | 744 | 723 | 702 | 683 | 753 | 734 |
| 10^{4.0} dPa · s [° C.] | 1,010 | 1,092 | 1,059 | 1,020 | 979 | 1,119 | 1,065 |
| 10^{3.0} dPa · s [° C.] | 1,195 | 1,291 | 1,251 | 1,206 | 1,157 | 1,319 | 1,260 |
| 10^{2.5} dPa · s [° C.] | 1,317 | 1,420 | 1,376 | 1,330 | 1,277 | 1,448 | 1,385 |
| α [×10⁻⁷/° C.] | 107 | 88 | 94 | 100 | 106 | 89 | 95 |
| (30° C.-380° C.) | | | | | | | |
| E [GPa] | 71 | 72 | 71 | 71 | Not | 70 | 71 |
| | | | | | measured | | |
| Specific Young's modulus | 28.4 | 29.5 | 28.9 | 28.8 | Not | 28.7 | 28.8 |
| [GPa/(g/cm³)] | | | | | measured | | |
| TL [° C.] | 915 | 900 | 870 | 880 | 845 | 900 | 885 |
| Logη at TL [dPa · s] | 4.7 | 5.5 | 5.5 | 5.1 | 5.2 | 5.7 | 5.5 |
| CS [MPa] | 660 | 864 | 834 | 768 | 717 | 909 | 868 |
| DOL [μm] | 35 | 23 | 25 | 28 | 32 | 23 | 25 |

TABLE 3

| Glass composition [mass %] | No. 15 | No. 16 | No. 17 | No. 18 | No. 19 | No. 20 | No. 21 |
|---|---|---|---|---|---|---|---|
| SiO₂ | 53.5 | 51.5 | 59.5 | 59.5 | 59.5 | 59.5 | 57.5 |
| Al₂O₃ | 16.0 | 16.0 | 10.0 | 12.0 | 14.0 | 18.0 | 12.0 |
| B₂O₃ | 7.0 | 7.0 | 5.0 | 5.0 | 5.0 | 5.0 | 5.0 |
| Na₂O | 18.0 | 20.0 | 14.0 | 14.0 | 14.0 | 14.0 | 16.0 |
| K₂O | 2.0 | 2.0 | 8.0 | 6.0 | 4.0 | 0.0 | 6.0 |
| MgO | 3.0 | 3.0 | 3.0 | 3.0 | 3.0 | 3.0 | 3.0 |
| SnO₂ | 0.5 | 0.5 | 0.5 | 0.5 | 0.5 | 0.5 | 0.5 |
| Density [g/cm³] | 2.48 | 2.49 | 2.48 | 2.47 | 2.46 | 2.43 | 2.48 |
| Ps [° C.] | 508 | 498 | 488 | 504 | 518 | 554 | 491 |
| Ta [° C.] | 543 | 532 | 524 | 540 | 556 | 598 | 526 |
| Ts [° C.] | 707 | 688 | 692 | 716 | 741 | 820 | 692 |
| 10^{4.0} dPa · s [° C.] | 1,032 | 994 | 1,009 | 1,058 | 1,102 | 1,205 | 1,025 |
| 10^{3.0} dPa · s [° C.] | 1,221 | 1,175 | 1,199 | 1,255 | 1,304 | 1,405 | 1,216 |
| 10^{2.5} dPa · s [° C.] | 1,341 | 1,294 | 1,323 | 1,385 | 1,434 | 1,528 | 1,344 |
| α [×10⁻⁷/° C.] | 101 | 107 | 106 | 101 | 95 | 80 | Not |
| (30° C.-380° C.) | | | | | | | measured |
| E [GPa] | 71 | Not | Not | 71 | 71 | 69 | 71 |
| | | measured | measured | | | | |
| Specific Young's modulus | 28.6 | Not | Not | 28.8 | 28.9 | 28.5 | 28.7 |
| [GPa/(g/cm³)] | | measured | measured | | | | |
| TL [° C.] | 850 | 805 | 860 | 885 | 885 | 1,020 | 880 |
| Logη at TL [dPa · s] | 5.5 | 5.7 | 5.2 | 5.3 | 5.7 | 5.3 | 5.1 |
| CS [MPa] | 788 | 681 | 568 | 680 | 793 | 1,036 | 609 |
| DOL [μm] | 27 | 32 | 38 | 39 | 32 | 23 | 42 |

TABLE 4

| Glass composition [mass %] | No. 22 | No. 23 | No. 24 | No. 25 | No. 26 | No. 27 | No. 28 |
|---|---|---|---|---|---|---|---|
| SiO₂ | 57.5 | 57.5 | 55.5 | 55.5 | 57.5 | 57.5 | 57.5 |
| Al₂O₃ | 14.0 | 18.0 | 14.0 | 18.0 | 10.0 | 12.0 | 14.0 |
| B₂O₃ | 5.0 | 5.0 | 5.0 | 5.0 | 7.0 | 7.0 | 7.0 |
| Na₂O | 16.0 | 16.0 | 18.0 | 18.0 | 14.0 | 14.0 | 14.0 |
| K₂O | 4.0 | 0.0 | 4.0 | 0.0 | 8.0 | 6.0 | 4.0 |
| MgO | 3.0 | 3.0 | 3.0 | 3.0 | 3.0 | 3.0 | 3.0 |
| SnO₂ | 0.5 | 0.5 | 0.5 | 0.5 | 0.5 | 0.5 | 0.5 |
| Density [g/cm³] | 2.48 | 2.45 | 2.49 | 2.45 | 2.47 | 2.46 | 2.46 |
| Ps [° C.] | 506 | 540 | 493 | 513 | 491 | 502 | 528 |
| Ta [° C.] | 542 | 581 | 528 | 549 | 526 | 537 | 565 |
| Ts [° C.] | 719 | 785 | 692 | 722 | 684 | 701 | 749 |
| 10^{4.0} dPa · s [° C.] | 1,052 | 1,151 | 1,016 | Not | 1,011 | 1,028 | 1,083 |
| | | | | measured | | | |
| 10^{3.0} dPa · s [° C.] | 1,247 | 1,347 | 1,204 | Not | 1,203 | 1,221 | 1,277 |
| | | | | measured | | | |
| 10^{2.5} dPa · s [° C.] | 1,372 | 1,471 | 1,329 | Not | 1,329 | 1,346 | 1,402 |
| | | | | measured | | | |
| α [×10⁻⁷/° C.] | Not | Not | Not | Not | Not | Not | Not |
| (30° C.-380° C.) | measured | measured | measured | measured | measured | measured | measured |
| E [GPa] | 71 | 70 | 71 | 72 | 72 | 72 | 70 |
| Specific Young's modulus | 28.8 | 28.5 | 28.6 | 29.4 | 29.0 | 29.0 | 28.5 |
| [GPa/(g/cm³)] | | | | | | | |
| TL [° C.] | 890 | 1,000 | 885 | 990 | 850 | 845 | 880 |
| Logη at TL [dPa · s] | 5.3 | 5.1 | 5.0 | 5.0 | 5.3 | 5.5 | 5.7 |
| CS [MPa] | 729 | 1,019 | 670 | 818 | 607 | 704 | 899 |
| DOL [μm] | 34 | 23 | 38 | 27 | 34 | 33 | 26 |

TABLE 5

| Glass composition [mass %] | No. 29 | No. 30 | No. 31 | No. 32 | No. 33 | No. 34 | No. 35 |
|---|---|---|---|---|---|---|---|
| SiO₂ | 57.5 | 55.5 | 55.5 | 55.5 | 53.5 | 53.5 | 61.7 |
| Al₂O₃ | 18.0 | 12.0 | 14.0 | 18.0 | 14.0 | 18.0 | 19.8 |
| B₂O₃ | 7.0 | 7.0 | 7.0 | 7.0 | 7.0 | 7.0 | 3.6 |
| Na₂O | 14.0 | 16.0 | 16.0 | 16.0 | 18.0 | 18.0 | 13.2 |
| K₂O | 0.0 | 6.0 | 4.0 | 0.0 | 4.0 | 0.0 | 0.0 |
| MgO | 3.0 | 3.0 | 3.0 | 3.0 | 3.0 | 3.0 | 1.5 |
| SnO₂ | 0.5 | 0.5 | 0.5 | 0.5 | 0.5 | 0.5 | 0.2 |
| Density [g/cm³] | 2.43 | 2.48 | 2.48 | 2.45 | 2.49 | 2.47 | 2.40 |
| Ps [° C.] | 541 | 494 | 506 | 534 | 494 | 524 | 575 |
| Ta [° C.] | 582 | 529 | 541 | 572 | 528 | 559 | 629 |
| Ts [° C.] | 790 | 685 | 704 | 761 | 682 | 732 | 905 |
| 10^{4.0} dPa · s [° C.] | 1,165 | 991 | 1,032 | 1,104 | 979 | 1,066 | 1,325 |
| 10^{3.0} dPa · s [° C.] | 1,363 | 1,175 | 1,223 | 1,295 | 1,162 | 1,254 | 1,534 |
| 10^{2.5} dPa · s [° C.] | 1,486 | 1,298 | 1,348 | 1,418 | 1,283 | 1,373 | 1,679 |
| α [×10⁻⁷/° C.] | Not | Not | Not | Not | Not | Not | 76 |
| (30° C.-380° C.) | measured | measured | measured | measured | measured | measured | |
| E [GPa] | 69 | 71 | 72 | 69 | 72 | 70 | 66 |
| Specific Young's modulus | 28.4 | 28.7 | 28.9 | 28.4 | 28.8 | 28.4 | 27.5 |
| [GPa/(g/cm³)] | | | | | | | |
| TL [° C.] | 995 | 840 | 840 | 970 | 860 | 970 | 985 |
| Logη at TL [dPa · s] | 5.2 | 5.3 | 5.6 | 5.0 | 5.0 | 4.7 | 6.6 |
| CS [MPa] | 1,007 | 671 | 764 | 989 | 686 | 935 | 983 |
| DOL [μm] | 20 | 33 | 29 | 19 | 35 | 23 | 34 |

TABLE 6

| Glass composition | | | |
|---|---|---|---|
| [mass %] | No. 36 | No. 37 | No. 38 |
| SiO₂ | 58.8 | 61.0 | 64.5 |
| Al₂O₃ | 21.5 | 12.8 | 16.3 |
| B₂O₃ | 4.9 | 0.0 | 0.0 |
| Na₂O | 13.1 | 12.3 | 13.8 |
| K₂O | 0.0 | 5.9 | 0.2 |
| MgO | 1.5 | 6.5 | 5.1 |
| CaO | 0.0 | 0.2 | 0.0 |
| ZrO₂ | 0.0 | 1.0 | 0.1 |
| SnO₂ | 0.2 | 0.0 | 0.0 |
| Density [g/cm³] | 2.40 | 2.48 | 2.44 |
| Ps [° C.] | 577 | 555 | 601 |
| Ta [° C.] | 631 | 602 | 652 |
| Ts [° C.] | 897 | 826 | 894 |
| 10^{4.0} dPa · s [° C.] | 1,302 | 1,171 | 1,257 |
| 10^{3.0} dPa · s [° C.] | 1,495 | 1,354 | 1,450 |
| 10^{2.5} dPa · s [° C.] | 1,616 | 1,477 | 1,572 |
| α [×10⁻⁷/° C.] | 77 | 96 | 79 |
| (30° C.-380° C.) | | | |
| E [GPa] | Not | 73 | 72 |
| | measured | | |
| Specific Young's | Not | 29.4 | 29.5 |
| modulus | measured | | |
| [GPa/(g/cm³)] | | | |
| TL [° C.] | 1,016 | 1,107 | 1,174 |
| Logη at TL [dPa · s] | 6.6 | 4.5 | 4.6 |
| CS [MPa] | 1,010 | 820 | 1,050 |
| DOL [μm] | 32 | 41 | 30 |

Each sample was prepared as described below. First, glass raw materials were blended so as to achieve the glass composition shown in the tables, and the resultant was melted at 1,580° C. for 8 hours by using a platinum pot. Next, the molten glass was poured onto a carbon sheet and formed into a sheet shape. Various properties of the resultant glass substrate were evaluated.

The density is a value measured by a well-known known Archimedes method.

The strain point Ps and the annealing point Ta are values measured based on a method of ASTM C336.

The softening point Ts is a value measured based on a method of ASTM C338.

The temperatures at viscosities at high temperature of 10^{4.0} dPa·s, 10^{3.0} dPa·s, and 10^{2.5} dPa·s are values measured by a platinum sphere pull up method.

The thermal expansion coefficient a is a value measured with a dilatometer and is an average value in the temperature range of from 30° C. to 380° C.

The Young's modulus E is a value measured by a flexural resonance method. In addition, the specific Young's modulus is a value obtained by dividing the Young's modulus E by the density.

The liquidus temperature TL is a value obtained as follows: the glass is pulverized; then glass powder that passes through a standard 30-mesh sieve (sieve opening: 500 μm) and remains on a 50-mesh sieve (sieve opening: 300 μm) is placed in a platinum boat and kept for 24 hours in a gradient heating furnace; and a temperature at which a crystal is deposited is measured.

The liquidus viscosity logη at TL is a value obtained by measuring the viscosity of glass at a liquidus temperature TL by a platinum ball pull up method.

Each sample was immersed in a KNO₃ bath kept at 430° C. for 4 hours and ion exchange treatment was performed. After the ion exchange treatment, the compressive stress value CS and depth of layer DOL of the compressive stress layer were measured. The compressive stress value CS and the depth of layer DOL were calculated by observing the number of interference fringes and the intervals of the interference fringes using a surface stress meter (FSM-6000 manufactured by Toshiba Corporation). A refractive index was set to 1.52 and an optical elastic constant was set to 30 [(nm/cm)/MPa] for each sample upon calculation.

It should be noted that, in preparing each sample in the tables, a molten glass was flown, formed into a substrate shape, and then the glass substrate was optically polished before the ion exchange treatment, for convenience of description of the present invention. In the case of manufacturing the tempered glass on an industrial scale, the following procedure is preferred: a glass substrate is formed by an overflow down-draw method or the like and cut processed into a rectangular shape; and then the glass substrate in a state in which its surface is unpolished is subjected to thermal processing to be formed into a predetermined shape; the end surface of the glass substrate is subjected to grinding and/or polishing to be formed into a predetermined shape, as required; the glass substrate is further subjected to ion exchange treatment to produce the tempered glass; and the end surface of the tempered glass is subjected to grinding and/or polishing to be formed into a predetermined shape, as required.

### Example 2

With regard to Sample Nos. 1 to 38, a glass substrate to be tempered having a thickness of 0.7 mm was produced by an overflow down-draw method. Then, the glass substrate to be tempered was subjected to press molding using a mold made of mullite at a temperature 30° C. lower than the softening point, and further subjected to ion exchange treatment by being immersed in a KNO₃ bath kept at 430° C. for 4 hours. Thus, tempered glasses having shapes illustrated in FIG. 1a, FIG. 3a to FIG. 3c, and FIG. 5 were each produced.

### Example 3

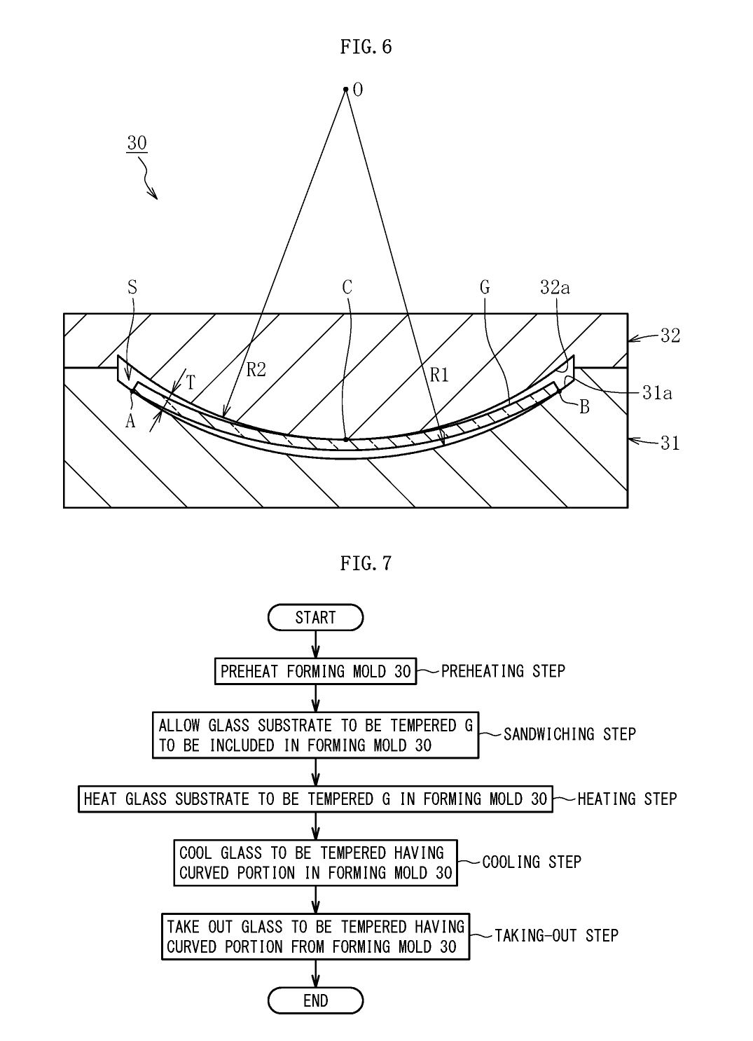

With regard to Sample Nos. 1 to 38, a glass substrate to be tempered having a thickness of 0.5 mm was produced by an overflow down-draw method. Then, glasses to be tempered having shapes illustrated in FIG. 1d and FIG. 1e were each produced by using a mold made of mullite illustrated in FIG. 6 according to steps illustrated in FIG. 7. The details are described below with reference to FIG. 6 and FIG. 7.

FIG. 6 is a longitudinal sectional side view for illustrating a forming mold for forming into a glass to be tempered having a curved portion. As illustrated in FIG. 6, a forming mold 30 comprises a lower die 31 having a concave curved surface 31a and an upper die 32 having a convex curved surface 32a facing the concave curved surface 31a. The concave curved surface 31a and the convex curved surface 32a are each curved at a constant curvature only along the lateral direction of FIG. 6 (along a single direction) while the curved surfaces 31a and 32a have the same center 0 of curvature with each other. That is, the curved surfaces 31a and 32a are each a partial cylindrical surface centered at an axis passing the center 0 of curvature in a direction normal to the paper. In addition, the curved surfaces 31a and 32a have radii of curvature R1 and R2, respectively (R1>R2). Between the curved surfaces 31a and 32a, there is formed a curve forming space S for including a glass substrate G to be tempered to be formed, the curve forming space S having a convex shape in a downward direction. A thickness T of the curve forming space S is constant and larger than the thickness of the glass substrate G to be tempered. It should be noted that the “thickness T of the curve forming space S” refers to a separation distance between the concave curved surface 31a and the convex curved surface 32a along the normal line of the concave curved surface 31a (in this embodiment, the separation distance between the curved surfaces 31a and 32a is constant throughout the curve forming space S).

The glass substrate G to be tempered is sandwiched in in the curve forming space S in the sheet thickness direction by two positions on the concave curved surface 31a at a distance from each other (point A and point B illustrated in FIG. 6) and one position on the convex curved surface 32a at a position between the two positions (point C illustrated in FIG. 6), to be supported therein in a curved state. It should be noted that, in this embodiment, both the curved surfaces 31a and 32a are curved only along the lateral direction, and hence the glass substrate G to be tempered is brought into line contact with the concave curved surface 31a at the point A and the point B and concurrently with the convex curved surface 32a at the point C. In addition, the point C is located midway between the point A and the point B in the lateral direction.

FIG. 7 is a step flow chart for illustrating steps in this embodiment. As illustrated in FIG. 7, a step for forming the tempered glass having a shape illustrated in FIG. 1d comprises a preheating step of preheating the forming mold 30, a sandwiching step of allowing the glass substrate G to be tempered to be included in the forming mold 30, a heating step of heating the glass substrate G to be tempered in the forming mold 30 to form the glass substrate G to be tempered into the tempered glass having a shape illustrated in FIG. 1d, a cooling step of cooling the glass to be tempered having a shape illustrated in FIG. 1d in the forming mold 30, and a taking-out step of taking out the tempered glass having a shape illustrated in FIG. 1d from the forming mold 30. It should be noted that, in this embodiment, the movement of the forming mold 30 between some of the steps or in some of the steps is accomplished by conveyance using a conveyer.

In the preheating step, the forming mold 30 is preheated in a vacant state in which the glass substrate G to be tempered is not included by allowing the forming mold 30 to pass through the inside of a preheating furnace through conveyance using a conveyer. In this step, the preheating temperature of the forming mold 30 preferably falls within a temperature range of from 200° C. to 300° C. In the sandwiching step, the glass substrate G to be tempered at normal temperature (within a temperature range of 20° C.±15° C.) is included in the forming mold 30, which has been preheated, according to the embodiment already described the description of the forming mold 30. In this step, as already illustrated in FIG. 6, the glass substrate G to be tempered is sandwiched in the forming mold 30 in the sheet thickness direction by the two points on the concave curved surface 31a (point A and point B) and the one position on the convex curved surface 32a (point C), to be supported therein. With this, the glass substrate G to be tempered having a flat sheet shape at normal temperature is elastically deformed into a curved state (a state of being curved only along the lateral direction of FIG. 6). More specifically, the glass substrate G to be tempered included in the forming mold 30 (curve forming space S) is curved in the lateral direction of FIG. 6 (single direction) so that its upper surface in a central portion follows the convex curved surface 32a having a relatively small radius of curvature (=R2). In addition, the glass substrate G to be tempered included in the forming mold 30 (curve forming space S) is curved so that its lower surface in both end portions follow the concave curved surface 31a having a relatively large radius of curvature (=R1). Accordingly, the glass substrate G to be tempered is elastically deformed so that its radius of curvature is smaller in the central portion and larger in both the end portions.

In the heating step, the glass substrate G to be tempered, which has been elastically deformed, is heated to a temperature 25° C. lower than the softening point through the forming mold 30 by allowing the forming mold 30 in which the glass substrate G to be tempered is included to pass through the inside of a heating furnace through conveyance using a conveyer. With this, the glass substrate G to be tempered, which has been elastically deformed, is subjected to thermal processing. In the cooling step, the glass to be tempered after the thermal processing is cooled while being still included in the forming mold 30. In the taking-out step, the glass to be tempered included in the forming mold 30 is taken out from the forming mold 30. Through the steps described above, the glass to be tempered having a shape illustrated in FIG. 1d is obtained. Further, through polishing and/or grinding of the end surface of the glass to be tempered, the glass to be tempered having a shape illustrated in FIG. le is also obtained. Then, when those glasses to be tempered are subjected to ion exchange treatment, tempered glasses having shapes illustrated in FIG. 1d and FIG. 1e are obtained.

### INDUSTRIAL APPLICABILITY

The tempered glass of the present invention is suitable for cover glasses for a mobile phone, a digital camera, a PDA, a touch panel display, and the like. The tempered glass of the present invention is also suitable for exterior parts for a mobile phone, a mobile PC, a pointing device, and the like, in particular, for exterior parts each having a specific shape through a good use of its feature, i.e., excellent thermal processability. In addition, the tempered glass of the present invention can be expected to find applications each requiring a high mechanical strength, for example, window glasses, substrates for a magnetic disk, substrates for a flat panel display, substrates and cover glasses for a solar cell, cover glasses for a solid-state imaging device, and tableware, in addition to the above-mentioned applications.

### Reference Signs List

1, 4, 7, 14, 17, 20, 23 bent portion

2, 5, 8, 15, 18, 21, 24, 27 flat sheet portion

3, 6, 9, 11, 13, 16, 19, 22, 25 end surface

10, 12, 28 curved portion

26 protrusion

30 forming mold

31 lower die

31a concave curved surface

32 upper die

32a convex curved surface

1. A tempered glass having a compressive stress layer in a surface thereof,
wherein the tempered glass comprises as a glass composition, in terms of mass %, 45% to 75% of SiO₂, 10% to 30% of Al₂O₃, 0% to 20% of B₂O₃, and 10% to 25% of Na₂O.

2. The tempered glass according to claim 1, wherein the tempered glass has a bent portion and/or a curved portion.

3. The tempered glass according to claim 2, wherein the bent portion and/or the curved portion is formed through thermal processing.

4. The tempered glass according to claim 3, wherein the tempered glass is obtained through tempering treatment after the thermal processing.

5. The tempered glass according to claim 3, wherein an end surface of the tempered glass is subjected to grinding treatment and/or polishing treatment after the thermal processing and before tempering treatment.

6. The tempered glass according to claim 1, wherein the compressive stress layer has a compressive stress value CS of 500 MPa or more and a depth of layer DOL of 20 μm or more.

7. The tempered glass according to claim 1, wherein the tempered glass has a softening point of 800° C. or less.

8. The tempered glass according to 1, wherein the tempered glass has an annealing point of 600° C. or less.

9. The tempered glass according to claim 1, wherein the tempered glass has a strain point of 400° C. or more.

10. The tempered glass according to claim 1, wherein the tempered glass has a liquidus temperature of 1,200° C. or less.

11. The tempered glass according to claim 1, wherein the tempered glass has a liquidus viscosity of 10^{4.0} dPa·s or more.

12. The tempered glass according to claim 1, wherein the tempered glass has a thermal expansion coefficient of 50×10⁻⁷/° C. to 110×10⁻⁷/° C.

13. A tempered glass having a compressive stress layer in a surface thereof, wherein:
the tempered glass is substantially free of Li₂O in a glass composition;
the tempered glass has a softening point of 720° C. or less; and
the compressive stress layer has a compressive stress value CS of 500 MPa or more and a depth of layer DOL of 20 μm or more.

14. A glass to be tempered, comprising as a glass composition, in terms of mass %, 45% to 75% of SiO₂, 10% to 30% of Al₂O₃, 0% to 20% of B₂O₃, and 10% to 25% of Na₂O.

15. The glass to be tempered according to claim 14, wherein the glass to be tempered has a bent portion and/or a curved portion.

16. The glass to be tempered according to claim 14, wherein an end surface of the glass to be tempered is ground and/or polished.

17. A method of manufacturing a tempered glass, the method comprising:
subjecting a glass to be tempered to thermal processing; and then
subjecting the glass to be tempered to tempering treatment, to thereby obtain a tempered glass.

18. The method of manufacturing a tempered glass according to claim 17, wherein the glass to be tempered comprises as a glass composition, in terms of mass %, 45% to 75% of SiO₂, 10% to 30% of Al₂O₃, 0% to 20% of B₂O₃, and 10% to 25% of Na₂O.

19. The method of manufacturing a tempered glass according to claim 17, wherein the subjecting a glass to be tempered to thermal processing comprises forming a bent portion and/or a curved portion.

20. The method of manufacturing a tempered glass according to claim 17, the method further comprising a step of grinding and/or polishing an end surface before the subjecting the glass to be tempered to tempering treatment.

21. The method of manufacturing a tempered glass according to claim 17, the method further comprising a step of grinding and/or polishing an end surface after the subjecting the glass to be tempered to tempering treatment.
